(19) United States
(12) Patent Application Publication
(10) Pub. No.: US 2026/0234459 A1
(43) Pub. Date: Aug. 13, 2026

(54) SILICONE COMPOSITION CONTAINING CARBINOL FUNCTIONALIZED POLYORGANOSILOXANE

(71) Applicant: Dow Silicones Corporation, Midland, MI (US)

(72) Inventors: Dan Zhao, Midland, MI (US); Devin M. Ferguson, Midland, MI (US); Eric Joffre, Shepherd, MI (US); Bizhong Zhu, Midland, MI (US); Zhanjie Li, Midland, MI (US); Hannah C. Furnier, Hope, MI (US); Andrés E. Becerra, Midland, MI (US)

(21) Appl. No.: 19/471,031

(22) PCT Filed: Apr. 3, 2024
(86) PCT No.: PCT/US2024/022719

§ 371 Date: Sep. 30, 2025

Related U.S. Application Data
(60) Provisional application No. 63/460,068, filed on Apr. 18, 2023.

(51) Int. Cl. C09K 5/14; C08G 77/04; C08G 77/16; C08G 77/26; C08K 3/22

(52) U.S. Cl. CPC C09K 5/14; C08G 77/045; C08G 77/16; C08G 77/26; C08K 3/22; C08K 2003/2227; C08K 2201/001

(57) ABSTRACT

The present invention relates to a composition comprising thermally conductive filler particles; a compound of Formula 1: and a compound of Formula 2: wherein R, R′, R″, R′″; m; n; p; x; and y are defined herein. The composition of the present invention is useful as a thermally conductive composite that exhibits high thixotropy and polyorganosiloxane compatibility.

### BACKGROUND OF THE INVENTION

The present invention relates to a composition comprising a carbinol functionalized polyorganosiloxane and a thermally conductive filler material. The composition of the present invention provides an excellent balance of low shear and high shear viscosities.

Striking a balance between dispensability/flowability and storage stability presents a continuing challenge for thermally conductive polyorganosiloxane composites. Thermally conductive gap fillers require a balance of dispensability, squeeze force and fluid separation, whereas thermally conductive encapsulants or pottants require a balance of flowability, reduced filler settling, and reduced cake formation. The desired property balance for fillers and encapsulants is theoretically achievable by increasing the ratio of the low shear viscosity to the high shear viscosity, also known as the thixotropic index. This challenge has not been overcome, however, through conventional thixotropic agents (e.g., fumed silica, carbon black, aluminum silicate, calcium carbonate, polyethers, hydrogenated castor oil, and polyamide wax) because they increase both low and high shear viscosities and/or because they are incompatible with siloxanes.

WO 2022/164640 A1 discloses the use of succinic anhydride functionalized siloxanes as effective thixotropic agents in conductive compositions. However, these agents have been found to inhibit hydrosilylation cure. Accordingly, there is a need in the field of thermally conductive polyorganosiloxane composites to find an effective thixotropic agent that is compatible with polyorganosiloxanes and that does not inhibit hydrosilylation cure.

### SUMMARY OF THE INVENTION

The invention addresses a need in the art by providing a composition comprising:
a) from 60 to 95 weight percent of thermally conductive filler particles;
b) from 4.9 to 39.9 weight percent of a compound of Formula 1:

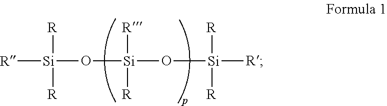

and
c) from 0.01 to 1 weight percent of a compound of Formula 2:

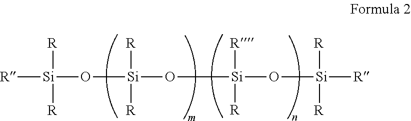

where each R is independently C₁-C₁₀-alkyl or phenyl; each R′ is C₁-C₄-alkyl, vinyl, or H; R″ and R″″ are each independently C₁-C₁₀-alkyl or a C₃-C₂₂ carbinol group; each R′″ is independently C₁-C₄-alkyl, phenyl, or H; m is from 5 to 150; n is from 0 to 20; and p is 40 to 800; with the proviso that when each R″ is C₁-C₁₀-alkyl, n is from 2 to 20 and R″″ is a C₃-C₂₂ carbinol group, and with the further proviso that when n is 0, each R″ is a C₃-C₂₂ carbinol group; wherein the weight percentages are based on the weights of the thermally conductive filler, the compound of Formula 1, and the compound of Formula 2.

The composition of the present invention is useful as a thermally conductive composite that exhibits high thixotropy and polyorganosiloxane compatibility. Moreover, the composite does not inhibit hydrosilylation cure.

### DETAILED DESCRIPTION OF THE INVENTION

The present invention is a composition comprising:
a) from 60 to 95 weight percent of thermally conductive filler particles;
b) from 4.9 to 39.9 weight percent of a compound of Formula 1:

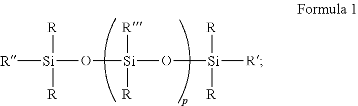

c) from 0.01 to 1 weight percent of a compound of Formula 2:

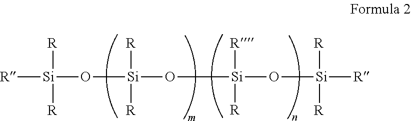

where each R is independently C₁-C₁₀-alkyl or phenyl; each R′ is C₁-C₄-alkyl, vinyl, or H; R″ and R″″ are each independently C₁-C₁₀-alkyl or a C₃-C₂₂ carbinol group; each R′″ is independently C₁-C₄-alkyl, phenyl, or H; m is from 5 to 150; n is from 0 to 20; and p is 40 to 800; with the proviso that when each R″ is C₁-C₁₀-alkyl, n is from 2 to 20 and R″″ is a C₃-C₂₂ carbinol group, and with the further proviso that when n is 0, each R″ is a C₃-C₂₂ carbinol group; wherein the weight percentages are based on the weights of the thermally conductive filler, the compound of Formula 1, and the compound of Formula 2.

Examples of suitable thermally conductive fillers include alumina, alumina trihydrate, zinc oxide, boron nitride, aluminum nitride, magnesium oxide, silicon carbide, and aluminum. The thermally conductive filler preferably comprises alumina, alumina trihydrate, or zinc oxide, or a combination thereof. The concentration of the thermally conductive filler is in the range of from 60 or from 65 weight percent to 95 weight percent, based on weight of the thermally conductive material, the compound of Formula 1, and the compound of Formula 2.

The D₅₀ volume mean diameter particle size of the filler particles is generally in the range of from 80 nm to 200 μm. A multimodal distribution of particle sizes is advantageously used to maximize packing. For example, D₅₀ particle sizes in the ranges of from 0.2 μm to 0.8 μm; from 1 μm to 5 μm; and from 10 μm to 30 μm are typical for alumina particles. For zinc oxide, a D₅₀ particle size in the range of from 100 nm to 200 nm is typical; and for alumina trihydrate, a D₅₀ particle size in the range of from 30 μm to 70 μm is typical.

The compound of Formula 1 is preferably represented by Formula 1a or Formula 1b:

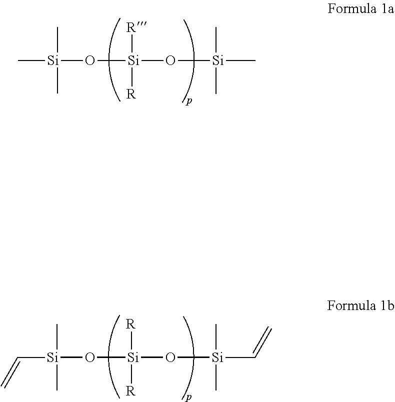

where p is in the range of from 40 to 800 or to 400 or to 300 or to 200, where each R and each R′″ are preferably independently phenyl or methyl.

The compound of Formula 2 can be represented by any of Formulas 2a, 2b, and 2c:

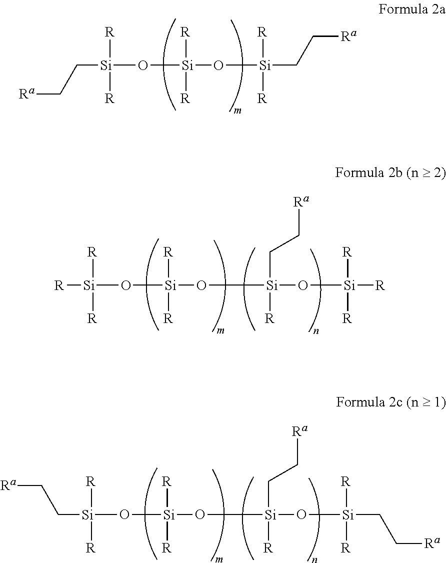

where R^{a} is a C₁-C₂₀ carbinol group. As used herein, “carbinol group” refers to a branched or linear alkyl group that contains one or more hydroxyl or thiol groups, preferably one or more hydroxyl groups and optionally ether, ester, or amine functionality. Compounds of Formula 2a where R″ is CH₂CH₂R^{a} is an unfunctionalized carbinol group or a carbinol group functionalized with ether or ether-amine groups may be prepared in accordance with Scheme 1:

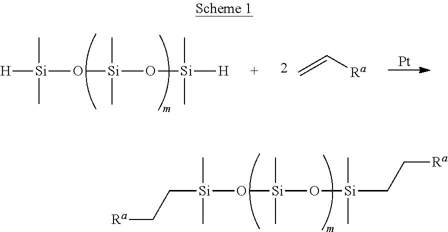

Examples of suitable=—R^{a} starting materials include the following compounds:

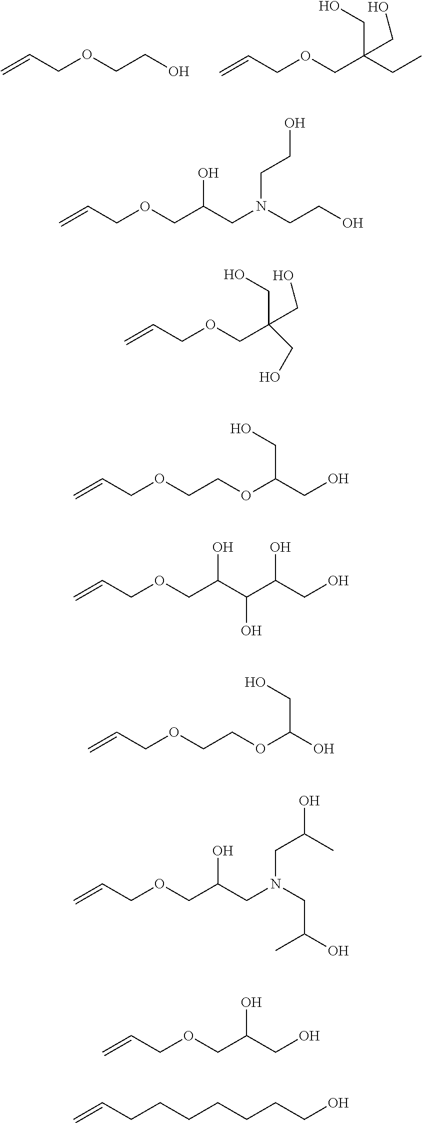

The corresponding carbinol groups R^{a} of the above listed compounds are:

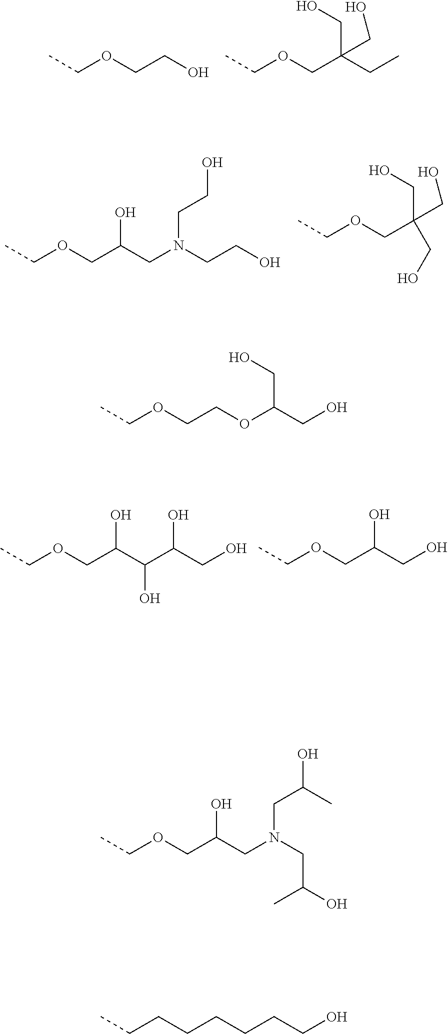

where the dashed lines represent the point of attachment to the ethylene bridge.

A compound of Formula 2a where R^{a} is a non-functionalized carbinol group may also be prepared in accordance with Scheme 2:

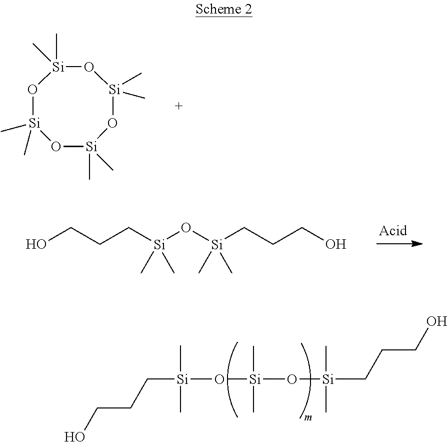

A compound of Formula 2a where R^{a} is functionalized with ester groups may be prepared in accordance with Scheme 3:

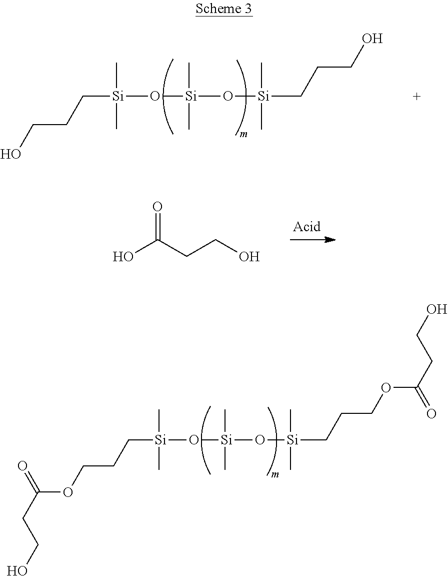

Compounds of Formulas 2b and 2c may be formed via hydrosilylation of either of the following precursors, Formula 2bₒ and 2cₒ:

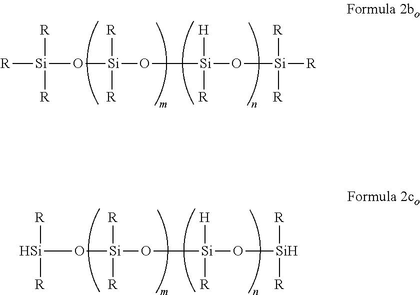

Where n is >0, R^{a} may further comprise from 1 or from 2, to 20 or to 10 or to 7 structural units of a C₁-C₂₀ hydrocarbyl group that optionally contains ether, ester, or amine groups, but no carbinol groups. For example, the hydrosilylation of Formula 2bₒ with a mixture of 2-allyloxyethanol and 3-ethoxyprop-1-ene forms a compound of Formula 2d:

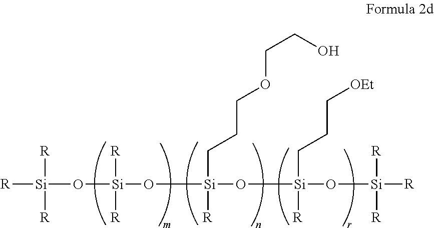

where r is from 1 to 20 or to 10 or to 7.

The concentration of compound of Formula 2 is in the range of from 0.01 or from 0.05 or from 0.1 weight percent, to 1 or to 0.8 or to 0.6 weight percent, based on the weights of the thermally conductive filler, the compound of Formula 1, and the compound of Formula 2.

The composition of the present invention may be curable or non-curable. A curable composition may be formed, for example, by hydrosilylation of a compound of Formula 1b and a compound of Formula 1cₒ:

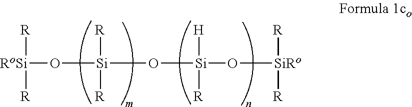

where R^{o} is methyl or H. The composition can be cured under hydrosilylating conditions in the presence of a hydrosilylating catalyst such as a platinum catalyst. The presence of carbinol groups in the compound of Formula 2 does not adversely impact the hydrosilylation reaction.

The composition of the present invention may further comprise one or more filler treating agents, examples of which include a C₁-C₁₆-alkyl-tri-C₁-C₆-alkoxy silane, or a C₁-C₁₆-alkyl-trimethoxy silane such as methyltrimethoxysilane or n-decyltrimethoxysilane; or a compound of Formula 3:

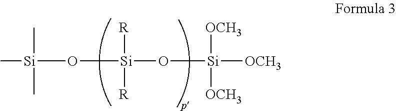

where p′ is in the range of from 20 to 200. When used, the concentration of the filler treating agent is in the range of from 0.5 or from 1 weight percent, to 5 or to 3 weight percent, based on the weight of the composition.

Preferably, the thermally conductive filler material, the compound of Formula 1, and the compound of Formula 2 comprise from at least 90 or from 95 or from 97 weight percent, to 100 weight percent of the composition.

Though not bound by theory, it is believed that the compound of Formula 2 increases the thixotropic index through bridging thermally conductive filler particles via hydrogen bonding, which is believed to be the cause of a marked increase in the low shear viscosity. At high shear, hydrogen bonding is presumed to be disrupted, thereby resulting in little or no increase in high shear viscosity.

As will be demonstrated with the following examples, the composition of the present invention provides improved thixotropic ratios over compositions that do not contain the compound of Formula 2. In the following examples, dp refers to degree of polymerization.

### EXAMPLES

### Intermediate Example 1—Preparation of an Ether Alcohol Polymer of Formula 2a (dp=7)

DOWSIL™ 1-8114 SiH Crosslinker (36.98 g, dp=7, A Trademark of The Dow Chemical Company or its Affiliates) was added to an oven-dried 100-mL 3-neck round bottom flask, fitted at the center neck with a condenser and N₂ flow. A thermocouple was inserted into the flask through a septum fitted on another neck, and the flask was heated to 60° C. with stirring. 2-Allyloxyethanol (Additive 1) was metered into the flask at a rate of 200 L/min using a syringe inserted through a septum fitted on the remaining neck. After feeding for 4 min, platinum(0)-1,3-divinyl-1,1,3,3-tetramethyldisiloxane complex solution in toluene (Pt catalyst, 30 μL) was then added to the round bottom flask. After 35 min of continued feeding of Additive 1, additional Pt catalyst (2.5 ppm) was added. After continued feeding for another 10 min, additional Pt catalyst (2.5 ppm) was added; after continued feeding for another 30 min, additional Pt catalyst (2.5 ppm) was added. After an additional 10 min, the feeding of the 2-allyloxyethanol was completed (15.93 g from onset of feeding), whereupon additional Pt catalyst (2.5 ppm) was added. The contents of the flask were stirred for 3 h, the heat was removed, and 5 wt % activated carbon (DARCO KB-G) was added. The mixture was allowed to stir at room temperature under an N₂ atmosphere for ~21 h, after which time the mixture was filtered through a 0.45 μm Nylon membrane (47 mm diameter) using N₂. The filtrate was collected in a flask, which was then equipped with a distillation apparatus and heated to 60° C. in vacuo for 1.5 h to remove unreacted Additive 1. The final product was analyzed by ¹H, ¹³C, and ²⁹Si NMR spectroscopy and was confirmed to be a compound of Formula 2a with the following structure:

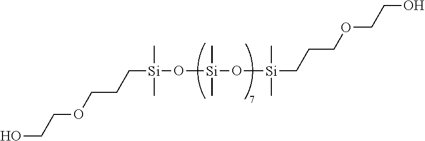

### Intermediate Example 2—Preparation of an Ether Alcohol Polymer of Formula 2a (dp=118)

The procedure for the preparation of Intermediate Example 1 was used with the following differences: Hydride Terminated Polydimethylsiloxane (53.30 g, dp=118, available from Gelest); and Additive 1 (1.59 g) were used. Additive 1 was metered into the flask for 1 min (200 μL), after which time the Pt catalyst (31 μL) was added to the flask. After an additional 10 min, the feeding of Additive 1 was completed. Heating was continued for an additional 30 min, after which time the mixture was stirred at room temperature under N₂ for 16 h. The product (50.50 g) was isolated and analyzed by ¹H, ¹³C, and ²⁹Si NMR spectroscopy and confirmed to be a compound of Formula 2a with the following structure:

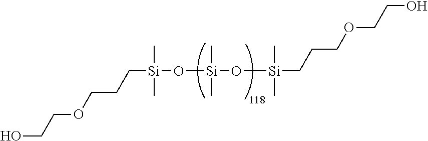

### Intermediate Example 3—Preparation of an Ether-Amine Alcohol Polymer of Formula 2a (dp=118)

Hydride Terminated Polydimethylsiloxane (53.33 g, dp=118) was added to an oven-dried 100-mL 3-neck round bottom flask, fitted at the center neck with a condenser and N₂ flow. A thermocouple was inserted into the flask through a septum fitted on another neck, and the flask was heated to 80° C. with stirring. 1,1′-[[2-Hydroxy-3-(2-propen-1-yloxy)propyl]imino]bis [2-propanol](Additive 2) was metered into the flask at a rate of 200 μL/min using a syringe inserted through a septum fitted on the remaining neck.

After metering Additive 2 for 1 min the Pt catalyst (33 μL) was added to the flask with more rapid stirring. After 25 min, the Additive 2 was completed. Heating was continued for 1.5 h, after which time additional Pt catalyst (33 μL) was added. Heating was continued for 25.5 h, after which time additional Pt catalyst (33 μL) was added. Heating continued for 2 h, after which time the heat source was removed. The mixture was stirred at room temperature under N₂ for 4 d. The crude product was dissolved in toluene and washed with deionized water. Carbon black was added to the isolated toluene layer, and the mixture was stirred under N₂. The carbon black was filtered through a 5-μm Nylon membrane and a layer of Celite under pressure. The headspace of the filtrate was swept with N₂ for 16 h. The filtrate was filtered again under pressure, and residual toluene was removed in vacuo at 90° C. for 2 h. The product was analyzed by ¹H, ¹³C, and ²⁹Si NMR spectroscopy and was confirmed to be the following polymer of Formula 2a:

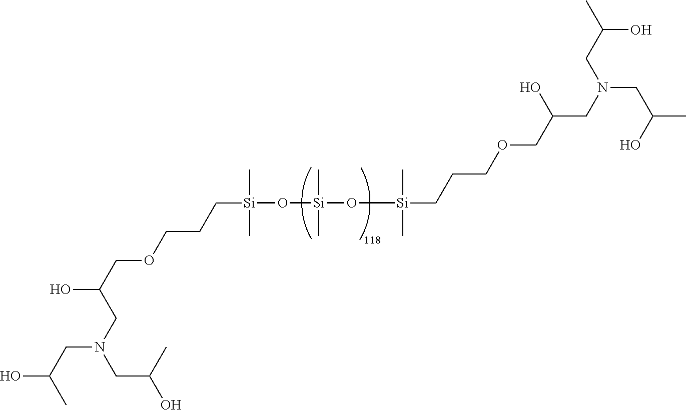

It has sometimes found to be advantageous to prepare ether-amine functionalized polymers of Formula 2a by a 2-step method, especially for low molecular polymers of Formula 2a. Intermediate 4 illustrates such an approach.

### Intermediate Example 4—Preparation of an Ether-Amine Alcohol Polymer of Formula 2a (dp=7)

### A. Preparation of a Glycidyl Ether Functionalized Polymer

DOWSIL™ 1-8114 SiH Crosslinker (36.98 g) was added to the center neck was attached a condenser with nitrogen flow. A thermocouple was inserted into the flask through a septum fitted on another neck, and the flask was heated to 70° C. with stirring. Allyl glycidyl ether (Additive 3) was metered into the flask at a rate of 200 μL/min using a syringe inserted through a septum fitted on the remaining neck.

After metering Additive 3 for 1 min the Pt catalyst (31 μL) was added to the flask. Addition of Additive 3 was completed (17.66 g total) and heating was continued for 16 h. The glycidyl ether functionalized polymer was transferred to a 250-mL single neck round bottom flask, and unreacted allyl glycidyl ether was removed in vacuo at 60° C. for 1 h, then at 90° C. for 2 h.

### B. Preparation of the Ether-Amine Alcohol Intermediate Example 3

Bis(2-hydroxypropyl)amine (9.40 g), and 2-propanol 1 (9.70 g) were added to a 250-mL 3-neck round bottom flask equipped with a stir bar and heating mantle. The contents were heated to 44° C., and the glycidyl ether functionalized polymer of Part A was added dropwise to the flask under N₂ through an addition funnel attached to the center neck of the flask. After 17 min, the addition was complete (29.46 g total), and stirring was increased. After 1 h, the temperature was increased to 60° C. After 16 h, the product mixture transferred to a flask where volatile material was removed in vacuo at 60° C. The final product collected and was confirmed by ¹H, ¹³C, and ²⁹Si NMR spectroscopy to be the following polymer of Formula 2a:

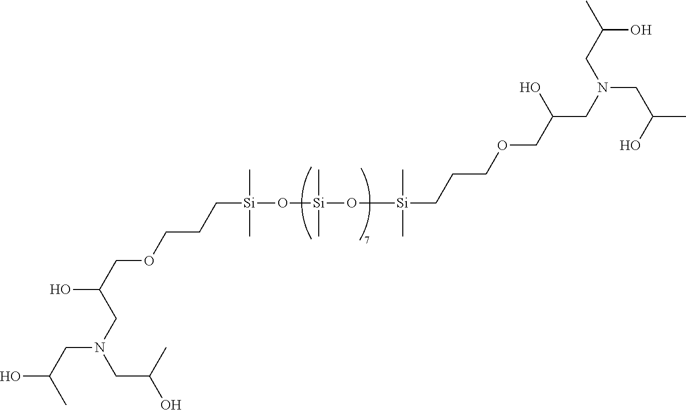

### Intermediate Example 5—Preparation of an Ether-Amine Alcohol Polymer of Formula 2b (m=113.9, n=6.5)

A trimethylsiloxy-terminated methylhydrosiloxane-dimethylsiloxane copolymer of Formula 2bₒ (117.8 g, m=113.9, n=6.5, CAS #68037-59-2) and Additive 1 (11.95 g) were added to an oven-dried 250-mL, 3-neck round bottom flask fitted at the center neck with a condenser and N₂ flow. A thermocouple was inserted into the flask through a septum fitted on another neck, a septum was fitted to the remaining neck, and the flask was heated to 60° C. with stirring. Pt catalyst (74 μL) was then added to the flask and heating and stirring for 100 min, after which time the reaction temperature was increased to 70° C. After 22 h of heating and stirring, additional Pt catalyst (5 ppm) and additional Additive 1 (2.39 g) were added. After continued heating and stirring for another 24.5 h, additional Pt catalyst (5 ppm) was added. After continued heating and stirring for another 105 min, the reaction temperature was increased to 90° C. After an additional 2 h of heating and stirring, additional Pt catalyst (5 ppm) was added. The contents of the flask were stirred for 23 h, the heat was removed, and the mixture was filtered through a pad of celite and a 0.45 μm Nylon membrane (47 mm diameter) under N₂. Unreacted Additive 1 was removed in vacuo at 90° C. for 1 h. The final product was analyzed by ¹H, ¹³C, and ²⁹Si NMR spectroscopy and was confirmed to be a compound of Formula 2b with the following structure:

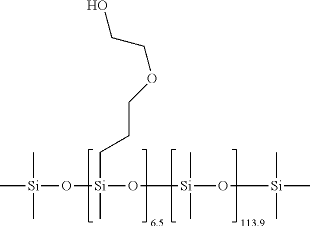

General Procedure for Preparation of Thermally Conductive Master Batches with Alumina Filler

The polymer of Formula 1a or the polymers of Formula 1b and A1000 SGD Alumina Particles (Al_{SGD}, D₅₀ diameter=0.5 μm, from Almatis) were added to a MAX100 dental cup and mixed at 2000 rpm in a Flacktek Speed mixer for 20 s. CB-P02 Spherical Alumina Particles (Al_{P02}, D₅₀ diameter=2 μm, from Showa Denko) were then added to the cup and mixing at 2000 rpm was continued for 20 s. A-SF-20 Spherical Alumina Particles (Al_{SF20}, D₅₀ diameter=20 μm, from Chalco) were then added to the cup and mixing was continued at 2000 rpm for another 20 s. The formulation was hand-mixed using a spatula, then mixed at 2500 rpm for 20 s, followed by a second round of hand-mixing and high-speed mixing for 20 s. The formulation was transferred to an aluminum pan and heated at 150° C. at 23 Torr for 1 h to form a thermal conductive master batch.

### Thermally Conductive Composite Viscosity Measurements

Oscillatory strain amplitude sweep measurements were performed for the thermally conductive silicone composites using an ARES G2 rheometer (TA Instruments) under a parallel plate configuration (25-mm diameter serrated steel plates). Samples were loaded into the rheometer and excess material was trimmed from the edge of the plates as necessary at plate gaps of 2.0 mm, 1.5 mm, 1.1 mm, and definitely at 1.05 mm. Testing was conducted at a gap of 1.0 mm. Prior to each measurement, the material was allowed to equilibrate for at least 5 min. The oscillation frequency for each sample was fixed at 10 rad/s and the strain amplitude was swept from 0.01% to 300% with 20 sampling points for each of the ranges between 0.01% and 0.1%; 0.1% and 1%; 1% and 10%; and 10% and 100%; and 10 sampling points between 100% and 300%. All measurements were carried out at 25° C. During these measurements, the storage modulus G′, the loss modulus G″, and the complex viscosity η* were recorded as a function of oscillation strain amplitude.

Table 1 illustrates formulations for three thermally conductive master batches (TC-1, TC-2, and TC-3). PDMS refers to DOWSIL™ 510 Fluid; PDVS₁₁₉ refers to DOWSIL™ SFD-119 Polymer; and PDVS₁₂₈ refers to SILASTIC™ SFD-128 Polymer. (SILASTIC and DOWSIL are Trademarks of The Dow Chemical Company or its Affiliates.)

TABLE 1
Thermally Conductive Master Batch
Formulations with Alumina Fillers

| | PDMS | PDVS₁₁₉ | PDVS₁₂₈ | A1_{SGD} | A1_{P02} | A1_{SF20} |
|---|---|---|---|---|---|---|
| TC | (g) | (g) | (g) | (g) | (g) | (g) |
| TC-1 | 27.32 | — | — | 7.27 | 21.80 | 43.61 |
| TC-2 | 5.90 | — | — | 9.41 | 28.23 | 56.46 |
| TC-3 | — | 17.58 | 2.63 | 7.98 | 23.94 | 47.88 |

### General Procedure for Preparing a Blend of Alumina Containing Composites and Thixotropic Additives

Masterbatch material (20 g) was added to a MAX20 dental cup, followed by addition of the thixotropic additive of Intermediate Example 1, 2, 3, or 5. The components were mixed at 1000 rpm for 20 s, followed by hand mixing, followed by another round of mixing at 1000 rpm for 20 s and hand-mixing. The formulation was stored at room conditions for 2 d before the oscillatory strain amplitude sweep measurements were recorded. Table 2 illustrates the thixotropic indexes (T.I.) for the thermally conductive composites with and without thixotropic additives. The symbols ηₘₐₓ and ηₘᵢₙ refer to the maximum low shear viscosity and minimum high shear viscosity, respectively. T.I.=ηₘₐₓ/ηₘᵢₙ.

TABLE 2
Thixotropic Indexes for Thermally
Conductive Composites with Alumina

| | | Wt % | | Wt % | ηₘₐₓ | ηₘᵢₙ | |
|---|---|---|---|---|---|---|---|
| Ex. | TC | Filler | Int. # | Additive | (Pa · s) | (Pa · s) | T.I. |
| CE 1 | TC-1 | 72.7 | None | 0 | 1 | 0.2 | 5 |
| CE 2 | TC-2 | 94.1 | None | 0 | 310 | 19.6 | 16 |
| CE 3 | TC-3 | 79.8 | None | 0 | 15.4 | 7.5 | 2 |
| Ex. 1 | TC-1 | 72.7 | Int. 1 | 0.5 | 30.6 | 0.3 | 90 |
| Ex. 2 | TC-2 | 94.1 | Int. 2 | 0.5 | 11,954 | 118.6 | 101 |
| Ex. 3 | TC-2 | 94.1 | Int. 1 | 0.1 | 31,794 | 162.6 | 196 |
| Ex. 4 | TC-3 | 79.8 | Int. 1 | 0.1 | 1525 | 10.3 | 148 |
| Ex. 5 | TC-2 | 94.1 | Int. 3 | 0.1 | 318,721 | 194.1 | 1642 |
| Ex. 6 | TC-3 | 79.8 | Int. 5 | 0.1 | 616 | 11.7 | 53 |

General Procedure for Preparation of Thermally Conductive Master Batches with ZnO, Alumina, and Alumina Trihydrate (TC-4)

Vinyl dimethyl-terminated dimethyl siloxane with a dynamic viscosity of 60 mPa·s (6.3 g), n-decyltrimethoxysilane (0.5 g), trimethylsilyl-terminated, trimethoxysilyl-terminated polydimethylsiloxane (1.2 g, dp=110) were added to a MAX100 dental cup and mixed at 2000 rpm in a Flacktek Speed mixer for 30 s, followed by addition of ZOCO102 ZnO (19.6 g, D₅₀=0.12 μm) and further mixing at 2000 rpm for 30 s. A-CF-3 Alumina (26.5 g, D₅₀=3 μm) was then added to the cup and the contents were further mixed at 2000 rpm for 30 s, followed by addition to the cup of MX-200 Alumina Trihydrate (45.9 g, D₅₀=45 μm). The formulation was further mixed at 2000 rpm for 30 s, after which time the formulation was hand-mixed using a spatula, then mixed at 2000 rpm for 30 s, followed by a second round of hand-mixing and high-speed mixing for 30 s. The formulation was transferred to an aluminum pan and heated at 150° C. at 23 Torr for 1 h to form the thermal conductive master batch. Table 3 illustrates the thixotropic index (T.I.) for TC-4 with and without thixotropic additives.

TABLE 3
Thixotropic Index for Thermally Conductive Composite
with ATH, ZnO, and Alumina

| | | Wt % | | Wt % | ηₘₐₓ | ηₘᵢₙ | |
|---|---|---|---|---|---|---|---|
| Ex. | TC | Filler | Int. # | Additive | (Pa · s) | (Pa · s) | T.I. |
| CE 4 | TC-4 | 92.0 | None | 0 | 1376 | 49 | 28 |
| Ex. 7 | TC-4 | 92.0 | Int. 4 | 0.1 | 18,195 | 108 | 169 |

1. A composition comprising:
a) from 60 to 95 weight percent of thermally conductive filler particles;
b) from 4.9 to 39.9 weight percent of a compound of Formula 1: 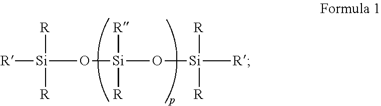
and
where each R is independently C₁-C₁₀-alkyl or phenyl; each R′ is C₁-C₄-alkyl, vinyl, or H; R″ and R″″ are each independently C₁-C₁₀-alkyl or a C₃-C₂₂ carbinol group;
each R′″ is independently C₁-C₄-alkyl, phenyl, or H; m is from 5 to 150; n is from 0 to 20; and p is 40 to 800; with the proviso that when each R″ is C₁-C₁₀-alkyl, n is from 2 to 20 and R″″ is a C₃-C₂₂ carbinol group, and with the further proviso that when n is 0, each R″ is a C₃-C₂₂ carbinol group; wherein the weight percentages are based on the weights of the thermally conductive filler, the compound of Formula 1, and the compound of Formula 2.

2. The composition of claim 1 wherein the thermally conductive filler particles are one or more thermally conductive filler particles selected from the group consisting of alumina, alumina trihydrate, and zinc oxide, and Formula 2 is represented by any of the following Formulas 2a, 2b, and 2c: 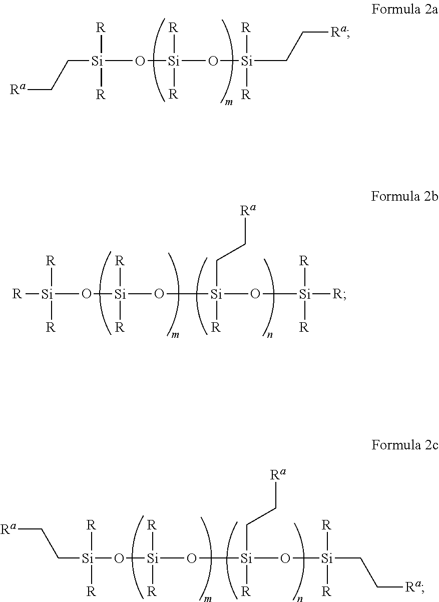
where R^{a} is a C₁-C₂₀ carbinol group that optionally contains ether, ester, or amine functionality; p is from 40 to 400; each R′ is methyl or vinyl; and each R′″ is independently methyl or phenyl; with the proviso that when Formula 2 is Formula 2b, n≥2; and with the proviso that when Formula 2 is Formula 2c, n≥1.

3. The composition of claim 2 where p is from 40 to 300; wherein Formula 2 is represented by Formula 2a or Formula 2b, and R^{a} is a C₃-C₂₂ carbinol group that contains ether or ether-amine functionality, wherein the thermally conductive filler particles are alumina particles or a combination of alumina, alumina trihydrate, and zinc oxide particles; and wherein the thermally conductive filler, the compound of Formula 1, and the compound of Formula 2 comprise at least 90 weight percent of the composition.

4. The composition of claim 3 wherein each R^{a} is independently selected from the group consisting of: 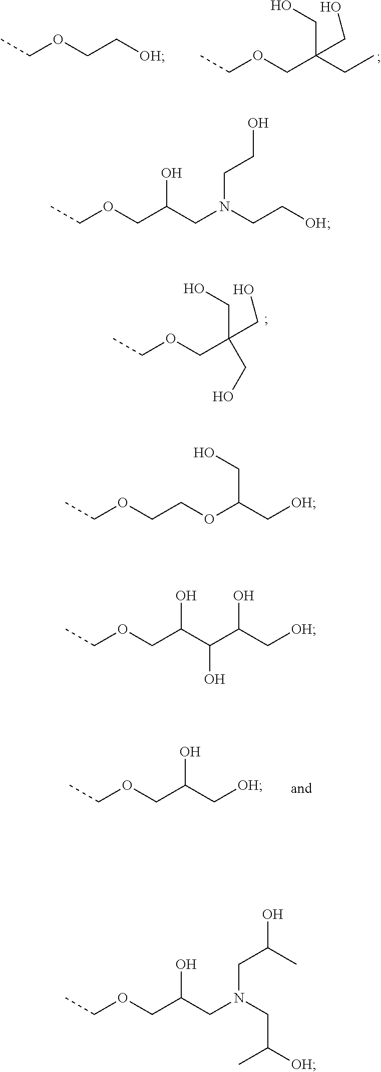
wherein the thermally conductive filler particles are alumina particles.

5. The composition of claim 3 wherein each R^{a} is independently

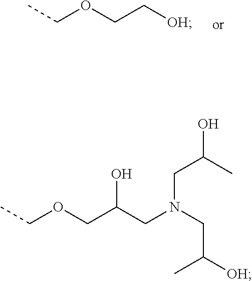

6. The composition of claim 3 which further comprises from 0.5 to 5 weight percent, based on the weight of the composition, of one or more filler treating agents selected from the group consisting of C₁-C₁₆-alkyl-tri-C₁-C₆-alkoxy silanes and a compound of Formula 3: 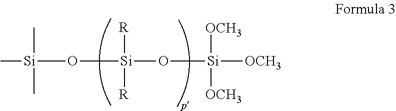
where each R is independently methyl or phenyl; and p′ is from 20 to 200; and
wherein the thermally conductive filler, the compound of Formula 1, and the compound of Formula 2 comprise at least 95 weight percent of the composition.

7. The composition of claim 4 which further comprises from 0.5 to 5 weight percent, based on the weight of the composition, of one or more filler treating agents selected from the group consisting of methyltrimethoxysilane or n-decyltrimethoxysilane or a compound of Formula 3: 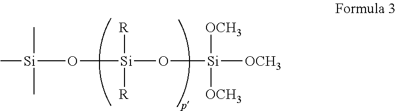
where each R is independently methyl or phenyl; and p′ is from 40 to 300.

8. The composition of claim 5 which further comprises from 1 to 3 weight percent, based on the weight of the composition, of one or more filler treating agents selected from the group consisting of methyltrimethoxysilane or n-decyltrimethoxysilane or a compound of Formula 3: 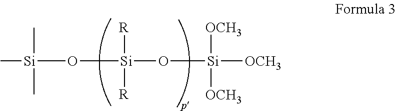
where each R is independently methyl or phenyl; and p′ is in the range of from 20 to 200.

9. The composition of claim 1 which is a curable composition, where the compound of Formula 1 comprises a mixture of compounds of Formula 1b and 1c: 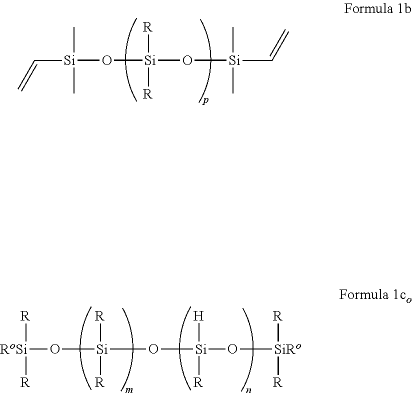
where each R is independently CH₃ or phenyl; each R^{o} is methyl or H; and wherein the composition further comprises a hydrosilylation catalyst.

10. The composition of claim 9 wherein the hydrosilylation catalyst is a platinum catalyst and wherein R^{a} is either
